(19) United States
(12) Patent Application Publication
(10) Pub. No.: US 2016/0156729 A1
(43) Pub. Date: Jun. 2, 2016

(54) STATE INFORMATION OFFLOADING FOR DIAMETER AGENTS

(71) Applicant: TELEFONAKTIEBOLAGET L M ERICSSON (PUBL), Stockholm (SE)

(72) Inventors: Kurt ESSIGMANN, Aachen (DE); Sven STEINACKER, Aachen (DE); Volker KLEINFELD, Aachen (DE); Gerasimos DIMITRIADIS, Thessaloniki (GR)

(21) Appl. No.: 14/906,440

(22) PCT Filed: Jul. 24, 2013
(86) PCT No.: PCT/EP2013/065655

§ 371 Date: Jan. 20, 2016

(51) Int. Cl. H04L 29/08; H04L 29/06

(52) U.S. Cl. CPC H04L 67/2819; H04L 65/105; H04L 67/42; H04L 65/1069

(57) ABSTRACT

The invention generally relates to a method, by a proxy agent, for establishing a communication session between a first and a second communicating entity over the proxy agent in a communication network. This session comprises a plurality of messages which are exchanged between the first communicating entity and the proxy agent and the proxy agent and the second communicating entity. The proxy agent inserts session information to a first message received by the first or the second communicating entity. The proxy agent then sends the first message to the first or the second communicating entity. The proxy agent then receives a second message by the first or the second communicating entity. This second message contains the session information which is then analysed by the proxy agent. Based on this session information the proxy agent sends a third message to the first or the second communicating entity.

### BACKGROUND

Proxy Agents are nodes that provide added value services in signaling networks. They are common in networks that use the Diameter base protocol in the application layer. In diameter protocol based networks a proxy agent is usually called a diameter proxy agent or simply a diameter agent. By understanding the application level semantics of the messages passing through them and possibly keeping state information about ongoing sessions and the transactions which are related to these sessions, proxy agents can modify the messages that traverse them, as well as affect the corresponding routing decisions for these messages.

Sessions comprise a number of transactions. Thus there is a difference between a transaction state and a session state. The transaction state is maintained by the diameter agents and lasts only for one message (e.g. Request and Response) exchange. The diameter agent sends a request and receives the answer for that response. The transaction states are maintained by the diameter agent for each message. A session state on the other hand can have the lifetime of one transaction or more than one transactions.

Sessions are considered to consist of transactions that share the same diameter session ID. Related transactions are considered those which even though they do not belong to the same explicit session, they still form a logical sequence and are thus part of an implicit session. In the latter case, these transactions usually share a common key, e.g. the contents of the User-Name Attribute Value Pairs (AVP). An attribute value pair is a data structure representing information in computing systems and applications. When the term ‘sessions’ is used from this point onwards, both explicit and implicit sessions are considered, as defined above. Also the term sessions is used to describe communication sessions.

The term stateful means that a current interaction is affected by the history of previous interactions.

Going into more detail and referring to FIG. 1, we consider a proxy agent 102 that is asked to handle a first, session-initiating request 1 from a peer node, which in FIG. 1 is a client 100. The session initiating request is a message (e.g. a request message) and can be referred to as a diameter message. Based on information contained within the diameter message, node wide state and possibly external queries/triggers, the proxy agent makes a decision on message manipulation and routing. Subsequently it forwards 2 the message to its next hop destination, which can be another diameter agent or the final destination (if directly connected). In FIG. 1 the next hop destination is shown as a server 104. If the handling of this message has led to the creation of some state information that needs to be maintained across transactions, then the agent 102 needs to store 3 this information in a local storage system 106. When the answer message is returned 4, if the state information is to be updated, the previously created entry needs to be recalled 5 and modified 6. This state information is filed using as key either the Session ID (explicit session) or data that has been drawn from an AVP within the message (implicit session).

When a subsequent transaction that belongs to the same session is received 8 by the agent 102, it recalls 9 the saved state information for this session. Based on this information and the contents of the diameter message, the proxy agent makes again a decision about the possible modification of the message and its subsequent routing. The message is then forwarded 10 to its next hop destination, which like above can be another diameter agent or the final destination, shown by the server 104 in FIG. 1.

In general, maintaining and using state information for numerous sessions and the related transactions is a resource consuming task. The maintenance of the state information has a memory footprint on the proxy agent that grows linearly with the number of active sessions and the related transactions, while the lookups that are involved when this information is to be modified and/or recalled may have an impact on the capacity of the proxy agent.

More specifically, keeping and modifying state information by the proxy agent presents certain disadvantages. In terms of storage, the proxy agent needs to keep in a local storage system information about all the sessions that are active at the time. The corresponding memory footprint grows linearly with the number of sessions. In terms of processor load, the act of looking up and retrieving the state information places additional load on the processor of the proxy agent. Furthermore, in order to avoid single points of failure, Diameter Agents are usually deployed in mated pair configurations. This means that the state information needs to be synched between the available agents, so that the most current state information for all sessions is available in both of them. This means that there is additional signaling needed in order to achieve this synchronization of the state information. Finally, since the active sessions need to be tracked, the agent must be able to discern both when a new session is established, but also when a session is terminated (with the latter being the more difficult of the two). The above disadvantages make the development of the proxy agent difficult and introduce complications in the system where the proxy agents are deployed.

### SUMMARY

Accordingly, a need exists to overcome the problems mentioned above and to make sure that keeping per session state information in a proxy agent is avoided by delegating this task to the two endpoints involved in the session, i.e. the client and the server.

This need is met by the features of the independent claims. Further embodiments are described in the dependent claims.

According to a first aspect of the invention, a method is provided for establishing a communication session between a first and a second communicating entity over a proxy agent in a communication network. This session comprises a plurality of messages which are exchanged between the first communicating entity and the proxy agent and the proxy agent and the second communicating entity. At first the proxy agent inserts a session information to a first message received by the first or the second communicating entity. Following that, the proxy agent sends the first message to the first or the second communicating entity. The proxy agent then receives a second message by the first or the second communicating entity. This second message contains the session information which is then analysed by the proxy agent. Based on this session information the proxy agent sends a third message to the first or the second communicating entity.

According to another aspect of the invention, a proxy agent is provided which is adapted to establish a communication session between a first and a second communicating entity in a communication network. The session comprises a plurality of messages exchanged between the first communicating entity and the proxy agent and the proxy agent and the second communicating entity. The proxy agent comprises an interface for receiving a first and a second message from the first or the second communicating entities. It further comprises an encoder for inserting a session information to a first message received by the first or the second communicating entity and a decoder for analysing said session information. The proxy agent finally comprises a processor for sending a third message to the first or the second communicating entity based on said session information.

### BRIEF DESCRIPTION OF THE DRAWINGS

The invention will be described in further detail with reference to the accompanying drawings.

FIG. 1 shows a stateful handling of transactions by a proxy agent

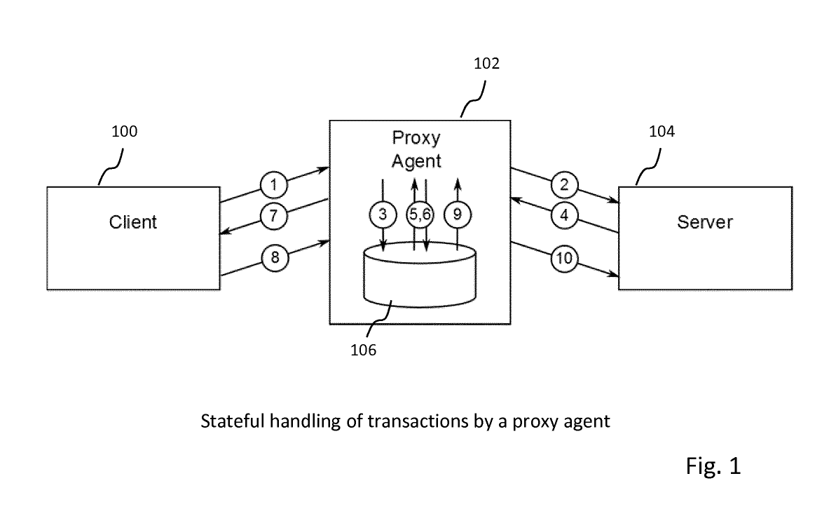

FIG. 2 shows state information being delegated to the client

FIG. 3 shows the extraction/reinjection of the state information in the forward direction

FIG. 4 shows state information being delegated to the server

FIG. 5 shows the extraction/reinjection of the state information in the backward direction

FIG. 6 shows a proxy agent according to the invention

### DETAILED DESCRIPTION

In the following different embodiments will be discussed which allow the delegation of maintaining session state information in the client and the server. It should be understood that each of the features discussed below might be used in the context described. However, they may also be used alone or in connection with any other feature described in the following detailed description.

As mentioned already, the current invention describes a method for avoiding the keeping and maintenance of per session state information in a Diameter proxy agent, but rather delegating this task to the two endpoints involved in the session, i.e. the client and the server. Since the proxy agent resides between the two communicating entities, it is able to modify the contents of a Diameter message on the way from the origin host to the destination host.

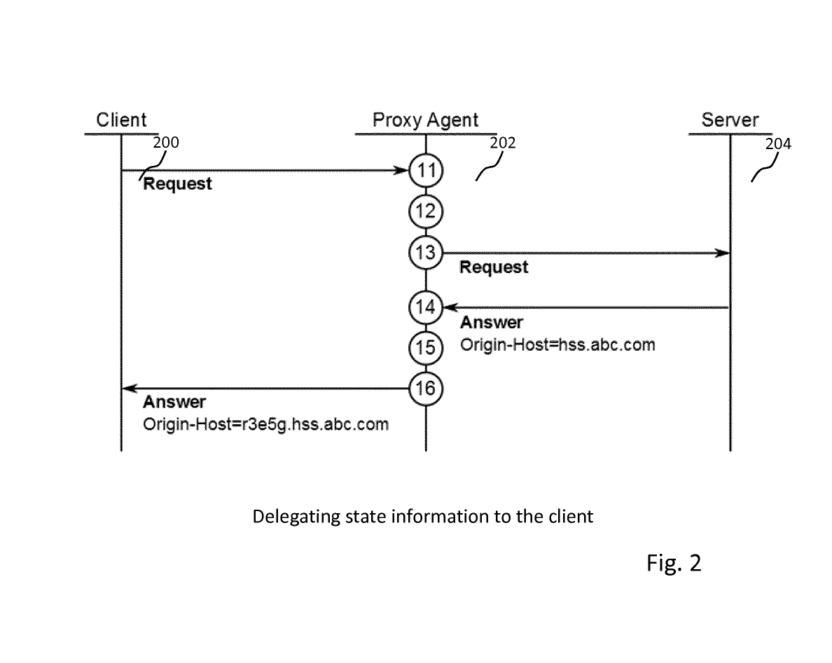

FIG. 2 shows how state information is delegated to the client 200. The client 200 may be referred to as a first communicating entity. A session is initiated by a request message 11 (e.g. an Authentication-Information-Request) sent by the client 200 and received at the proxy agent 202. The proxy agent 202 then examines the contents of the message. Based on these contents and possibly combined with node wide state information and/or external queries makes a decision regarding message modification as well as its routing 12. The message is then forwarded 13 to the peer that the routing decision selected. In this case this peer is the server 204. The server 204 can be referred to as a second communicating entity.

Node wide state information can be routing tables, defining where certain requests have to be routed, possible endpoints/peers connected to and served by the node, possible load that each peer can handle etc. The external queries can be queries made by the proxy agent in order to get extra information for deciding how to handle a certain request. These queries can be made to another server which is not part of the session or to a database containing information about certain peers. The message modification is usually made in order to, for example, filter information elements from the message. In that case there may be some sensitive information which is not supposed to stay in the message when it is further forwarded. As another example, the message may have to be modified for interoperability reasons i.e. the receiver of the message may have certain requirements for being able to read the message. As a third example, there may be information which can be deleted from the message in order to make it shorter.

When the corresponding answer 14 is received, the Origin-Host AVP shall contain the hostname of the actual server 204 that handled this request. The answer can be considered a first message. As shown in FIG. 2 this hostname is e.g. “hss.abc.com”. The proxy agent 202 knows that there is some state information to be saved. The knowledge of the proxy server on the state information to be saved may be derived from the message contents and/or the node configuration. The saving may either be done in the proxy agent or delegated to the client and/or the server. This information is encoded as a character string that can be used as part of an FQDN and is prepended in the Origin-Host address 15. The message with the state information carrying Origin-Host is then forwarded 16 by the proxy agent 202 towards the Client 200. In this case the hostname will be e.g. “r3e5g.hss.abc.com”. The “r3e5g” part of the hostname is the encoded character string which contains the state information. The hostname may also be referred to as the diameter identity. Furthermore, the diameter identity can have the form “r3e5ghss.abc.com”, meaning that the encoded character string does not need to be separated by the “hss” part. It is to be noted that the encoded character string mentioned above can have any form and length.

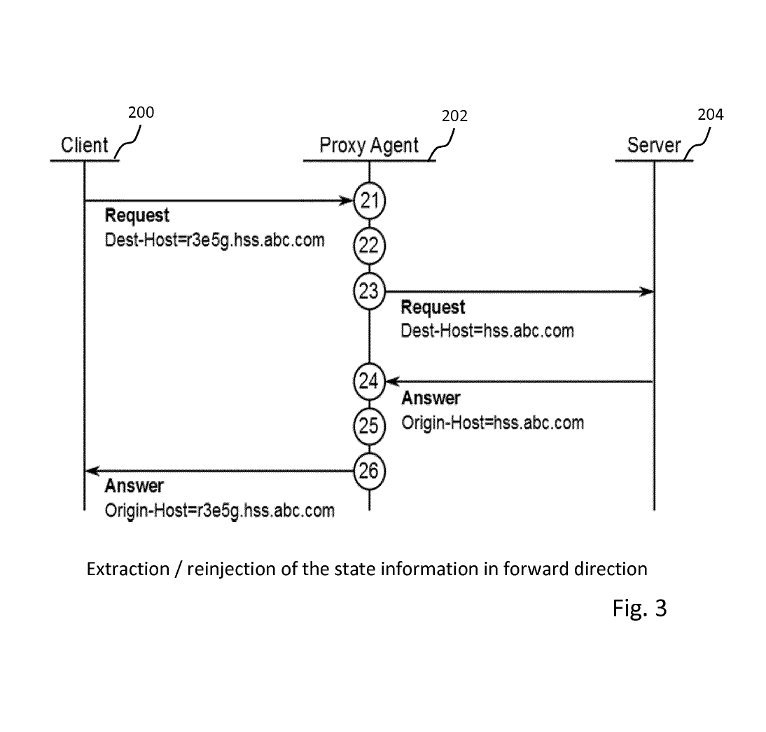

FIG. 3 shows the extraction/reinjection of the state information in the forward direction. By forward direction it is meant that the extraction and reinjection of the state information is made in the same direction that the initial request was made. In that case it is the client who made the initial request and also the one who has the state information. The proxy agent extracts the state information and also reinjects it.

When a subsequent request 21 from the same session made by the client 200 is received at the Proxy Agent 202 (e.g. a Notify-Request), it shall include the Destination-Host AVP since the name of the Server has been discovered with the first transaction. This request can be considered as a second message. This AVP shall contain also the state information that has been saved before. As mentioned the state information is included in the part added by the proxy agent to the hostname of the server 204. The proxy agent 202 receiving the request 21 can extract the state information and evaluate it. The result of this evaluation together with the message contents and possibly other criteria is used by the proxy agent 202 in order to make a decision regarding the message modification and the subsequent routing of the message 22. The message is then forwarded 23 to the peer (server 204) that the routing decision selected. The message can be considered a third message. In this step the state information is no longer part of the hostname.

When the corresponding answer is sent 24 from the server 204 to the proxy agent 202, the Origin-Host carried in it shall contain the actual Server name, e.g. hss.abc.com. The proxy agent can discover that state information has been saved for the transactions of this session (possibly by examining the transaction table). The Diameter protocol requires that agents maintain the transaction state in so called “transaction tables”. Diameter Agents keep an entry for each request that they have handled: this way incoming answers can be matched to requests, while future retransmissions are also possible. Such an entry can be seen as a transaction ID. The saved state is inserted 25 again in the Origin-Host AVP and the Answer message is then forwarded from the proxy agent 202 back towards the client 200. A possible use for such state information saving is the recording or hinting of the routing decision when a number of alternatives are available as next hop peers (e.g. for load sharing) and the proxy agent would like to consistently select the same peer to forward requests that belong to the same session. Such a mechanism can be referred to as session stickiness. Another possible usage is the saving of the configuration parameters that are employed for applying topology hiding to the requests that belong to the same session. Topology Hiding is applied when the proxy agent is situated at the edge of a network (Diameter Edge Agent—DEA). The DEA can change the hostnames (Diameter Identities) of the endpoints in the Home Network (both Clients/Servers) so that their real identities do not become known to entities outside the home network. This is what we call topology hiding.

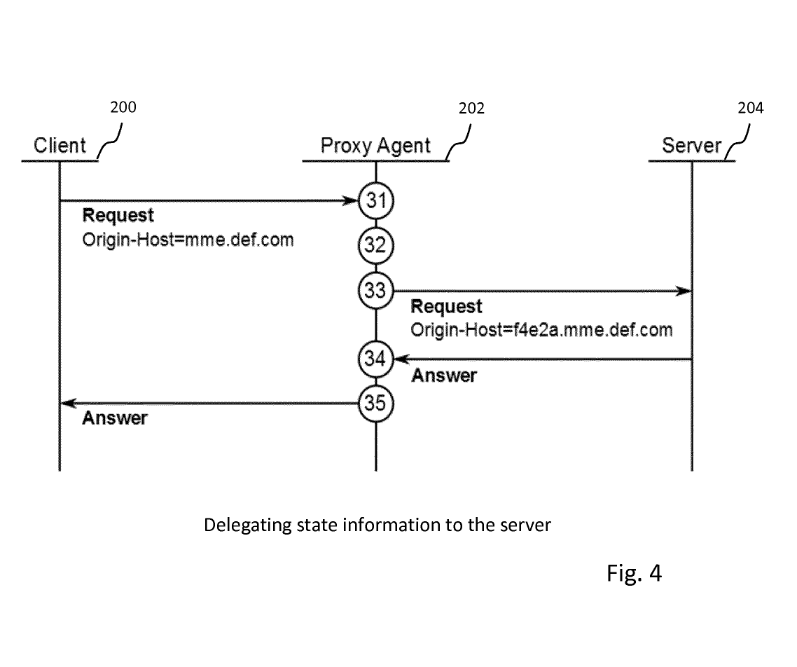

FIG. 4 shows state information being delegated to the server. The previous paragraphs dealt with the recalling of state information for transactions in the same direction as the one that initiated the session. The embodiment shown in FIG. 4 and described below shows the saving, extraction and usage of state information for request messages that are coming from the Server 204, i.e. for cases where a subsequent transaction direction is the opposite from the one that initiated the session. A session is initiated again by a request message 31 (e.g. a Cancel-Location-Request) received at the proxy agent 31. The proxy agent examines the contents of the message and based on them makes a decision regarding message modification and routing. Assuming that the proxy agent 202 wants to save some state information, it encodes it as a character string that can be used as part of an FQDN and prepends it 32 in the Origin-Host. The message is then forwarded to the peer that the routing decision selected 33. For this embodiment there is no special handling for the handling of the answer message in the reverse path 34, 35.

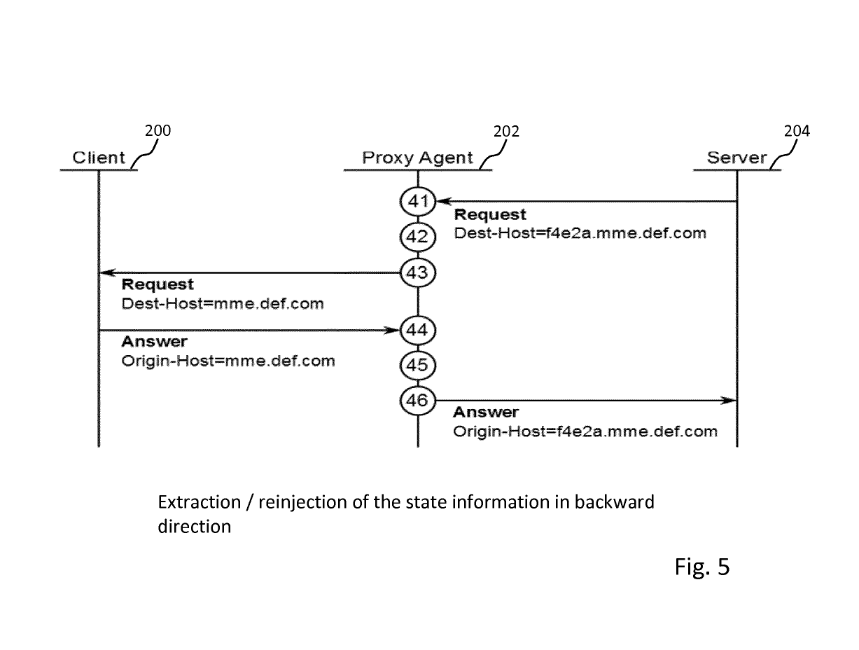

FIG. 5 shows the extraction/reinjection of the state information in the backward direction. By backward direction it is meant that the extraction and reinjection of the state information is made in the opposite direction that the initial request was made. In that case it is the client who made the initial request, but the server is the one that keeps the state information.

When a subsequent request belonging to the same implicit session is received 41 by the Proxy Agent (e.g. a Delete-Subscriber-Data-Request), it shall contain the Destination-Host AVP, e.g. “f4e2a.mme.def.com” since the name of the Client 200 was provided with the first transaction. This AVP shall contain also the state information that has been saved before as the encoded character string “f4e2a”. The proxy agent 202 extracts this information and evaluates it in combination with the message contents and possibly other criteria, in order to make a decision regarding the message modification and the subsequent routing 42. The message is then forwarded 43 to the peer, in this case the client 200, that the routing decision selected.

When the corresponding answer is received 44, the Origin-Host carried in it shall contain the actual Client 200 name. The proxy agent 202 finds (possibly by examining the transaction table) that state information has been saved for the transactions of this session. The saved state is included again in the Origin-Host AVP 45 and the Answer message is then forwarded 46 back towards the Server 204.

A possible usage of this invention would be to affect the routing decision that the proxy agent does in order to ensure that the same path is followed as the one that was used for the session initiating transaction. As a method though it can be used in other situations where such state information saving is needed.

It is possible to combine the methods that have been described above, in order to save state information for usage in later transactions either when they are initiated by the Client 200 or by the Server 204. Since these two directions are independent, it is not necessary to have the same state information saved in both cases.

Also, In the methods that have been described above, the state information was saved within the Origin-Host AVP. It is possible though to use other AVPs to achieve the same effects. One of them is the Origin-Realm AVP (useable in both forward and backward directions) and the Session-ID AVP (useable only for the backward direction). The Origin-Realm also carries a Diameter Identity, but it describes the administrative domain where the Origin-Host belongs (correspondingly the destination-realm contains the administrative domain of the destination-host). Both Client and Server generate their own host/realm identities, that are saved by the Server or Client and are used later. This is why it is possible to inject state info in either directions. Regarding the Session ID, the Client generates it and the same Id is reused also by the Server. In that way, the proxy agent has the possibility to change the Session ID only before it reaches the Server; the Client knows what the Session ID should be and thus no state information may be injected.

For most applications, the Client and Server names should not change within the lifetime of a session. For this reason, in the methods that have been described above, the state information is defined during the first transaction and from then on it is fixed. If the application allows it, it would be possible to update the state information at subsequent transactions. Updating the injected state information is experienced by the Client as if the Server name has changed (forward direction) or experienced by the Server as if the Client name has changed (backward direction).

In some applications this is detrimental, e.g. a Home Subscriber Server in a network may deduce by this that a new Mobility Management Entity is handling now a terminal and thus trigger a Cancel Location. Some applications may not be sensitive to such changes and may allow updates without problems. This embodiment takes advantage of this fact, allowing the state information to change during the session and not to be fixed and decided during the first transaction.

Those skilled in the art will with no doubt see that the methods described in this Invention could also be used for other applications that depend on keeping state information across transactions.

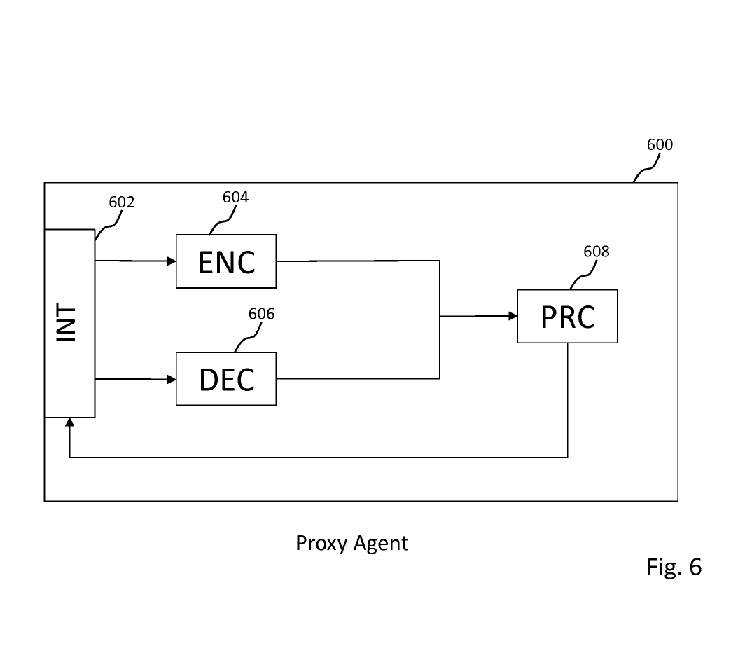

FIG. 6 shows a proxy agent 600 according to the invention. The proxy agent 600 is adapted to establish a communication session between two or more communicating entities in a communication network. These entities are usually a client and a server. Each session between the communicating entities comprises multiple messages which are exchanged between the client, the proxy agent and the server. For receiving these messages from the client and/or the server, the proxy agent comprises an interface 602. The interface 602 can also be adapted to send messages to the client and/or the server. The proxy agent 600 also comprises an encoder 604 which is adapted to insert session information of an on-going session to the messages that it receives and/or sends to the client and/or the server. Further the proxy agent 600 comprises a decoder which is adapted to extract session information of an on-going session from the messages that it receives from the client and/or the server. Both outputs of the encoder and the decoder are adapted to be forwarded to a processor 608 comprised in the proxy agent. These outputs contain the messages received at the interface 602. The processor is adapted, based on the session information that has been encoded in the encoder or decoded by the decoder, to determine to which communicating entity to send what message from the ones comprised in the session.

1. A method for establishing a communication session between a first and a second communicating entity over a proxy agent in a communication network, said session comprising a plurality of messages exchanged between the first communicating entity and the proxy agent and the proxy agent and the second communicating entity, the method comprises:
inserting a session information to a first message received by the first or the second communicating entity,
sending said first message to the first or the second communicating entity,
receiving a second message by the first or the second communicating entity, said second message containing said session information,
analysing said session information, and
sending a third message to the first or the second communicating entity based on said session information.

2. The method of claim 1, wherein the step of inserting comprises adding an information element to a fully qualified domain name of the first or the second communicating entity.

3. The method of claim 2, wherein the information element is an encoded character string.

4. The method of claim 1, wherein the session information comprises state information of the session and a session identification.

5. The method of claim 1, wherein the analysing comprises extracting the session information from the second message and evaluating said session information.

6. The method of claim 1, wherein the second message is consecutive to the first message and the third message is consecutive to the second message.

7. The method of claim 1, wherein the communication session is a diameter protocol based session.

8. The method of claim 1, wherein the proxy agent is a diameter protocol based agent.

9. The method of claim 1, wherein the plurality of messages comprise the same session identification.

10. A proxy agent adapted to establish a communication session between a first and a second communicating entity in a communication network, said session comprising a plurality of messages exchanged between the first communicating entity and the proxy agent and the proxy agent and the second communicating entity, the proxy agent comprising:
an interface configured to receive a first and a second message from the first or the second communicating entities,
an encoder configured to insert a session information to a first message received by the first or the second communicating entity,
a decoder configured to extract said session information from the second message received from the first or the second communication entities, and
a processor configured to send a third message to the first or the second communicating entity based on said session information.

11. A computer program product comprising a non-transitory computer readable medium storing computer program code to be executed by at least one processor of a network node, wherein execution of the program code causes the network node to:
receive a first and a second message from the first or the second communicating entities,
insert a session information to a first message received by the first or the second communicating entity,
extract said session information from the second message received from the first or the second communication entities, and
send a third message to the first or the second communicating entity based on said session information.

12. The proxy agent of claim 10, wherein the encoder is configured to preform the insert by adding an information element to a fully qualified domain name of the first or the second communicating entity.

13. The proxy agent of claim 12, wherein the information element is an encoded character string.

14. The proxy agent of claim 10, wherein the session information comprises state information of the session and a session identification.

15. The proxy agent of claim 10, wherein the decoder is configured to extract the session information from the second message and evaluating said session information.

16. The proxy agent of claim 10, wherein the second message is consecutive to the first message and the third message is consecutive to the second message.

17. The proxy agent of claim 10, wherein the communication session is a diameter protocol based session.

18. The proxy agent of claim 10, wherein the proxy agent is a diameter protocol based agent.

19. The proxy agent of claim 10, wherein the plurality of messages comprise the same session identification.
